(19) United States
(12) Patent Application Publication
(10) Pub. No.: US 2007/0215675 A1
(43) Pub. Date: Sep. 20, 2007

(54) Friction stir welding process to join two or more members in forming a three-dimensional joint

(75) Inventor: John E. Barnes, Roswell, GA (US)

Correspondence Address: ROBERT A. McLAUCHLAN, P.O. BOX 26780, AUSTIN, TX, 78755, US

(73) Assignee: Lockheed Martin Corporation

(21) Appl. No.: 11/377,944

(22) Filed: Mar. 17, 2006

(51) Int. Cl. B23K 20/12

(52) U.S. Cl. 228/112.1

(57) ABSTRACT

A three dimensional joint is formed by coupling (joining) a first structural member and a second structural member. This involves first aligning a first structural member to a second structural member. The first structural member has a channel with which to receive a portion of the second structural member. Once aligned, the first structural member and second structural member may be friction stir welded at the channel to plasticize the material adjacent to the channel of both the first structural member and the second structural member to form a friction stir weld joint. This allows three dimensional objects to be formed from the friction stir weld joined members as opposed to merely allowing the joining of flat two dimensional surfaces.

### TECHNICAL FIELD OF THE INVENTION

The present invention relates generally to structural joints and more particularly a method to join two or more members in forming a three-dimensional joint.

### BACKGROUND OF THE INVENTION

Structural beams translate stiffness and other mechanical loads within structures such as buildings, vehicles, and bridges, etc. In one example, structural beams may be used to translate loads associated with the wing of an aircraft. These structural beams may include box beams, I-beams, double I-beams, C-Beams or other like structures that are efficient load carrying members. FIGS. 1A and 1B provide a cross section of a typical I-Beam and C-Beam. Such beams may be used in a variety of applications. I-Beams may be used for long clear spans requiring heavy loads. While C-Beams can be used where design and load requirements allow use of a C-Beam as opposed to an I-Beam, which provides additional support. Additionally a C-Beam may provide one flush surface not present in the I-Beam.

These beams are typically joined together using fasteners. Structures constructed via bolted and fastened I-beams and C-beams often have problems translating stiffness and loads with minimal weight due to moment continuity. This joining method also requires drilling holes and installing fasteners to attach the members to one another. Such holes often produce localized stresses and mechanical loads that the beams must account for. To account for such localized loads, the structure of the beam may be reinforced resulting in increased weight and loads to be handled by the beams.

Additionally, set up, tooling and the time required to drill holes may become major drivers in manufacturing as well as issues in quality assurance. The installation of fasteners is also a process prone to quality assurance issues. (i.e. insuring that the proper fasteners are used with the proper torques)

Friction Stir Welding (FSW) is a joining method, as illustrated in FIG. 2 which has gained acceptance as a means for joining panels together. FSW produces a plasticized region 22 of material by pushing a non-consumable rotating tool 24 into the material of parts 26A and 26B that are to be welded. Then a central pin, or probe, 28 followed by the shoulder 30, is brought into contact with the two parts 26A and 26B to be joined. The rotation of tool 24 heats up and plasticizes the materials that the tool is in contact with. As tool 24 moves along the joint line 32, material from the front of the tool is swept around this plasticized annulus to the rear, so eliminating the interface.

There are cost advantages if one applies a simple stiffened skin structure that may be produced via FSW to the exterior of a vehicle such as an aircraft. The robustness and automation of the process is very attractive for manufacturing. However, smaller complex three dimensional structures, such as aircraft designs, have not been easily addressed by the application of FSW. The FSW process works best when two pieces abut one another and are clamped tightly together. This is most effectively achieved when the two pieces are forming a single two-dimensional surface. Joining and properly plasticizing three-dimensional surfaces is difficult. Thus it has been difficult to apply FSW processing to complex three-dimensional structures.

There are problems associated with each of these joining methods. The requirement to drill holes and install fasteners to attach beams to one another requires that the fastened beams be strengthened in order to account for the localized mechanical loads caused by the fasteners. Additionally, mechanical loads within the beams may be localized at the fastener site as opposed to being transferred across the entire joint interface.

Further limitations and disadvantages of conventional and traditional joining process and related structures and functionality will become apparent to one of ordinary skill in the art through comparison with the present invention described herein.

### SUMMARY OF THE INVENTION

The present invention provides a means of joining a first structural member and a second structural member that substantially addresses the above identified needs as well as others. Embodiments of the present invention provide a three dimensional joint formed by coupling (joining) a first structural member and a second structural member. This involves first aligning a first structural member to a second structural member. The first structural member has a channel with which to receive a portion of the second structural member. Additionally, this channel serves as a guide with which to position the first structural member relative to the second structural member. Once aligned, the first structural member and second structural member may be friction stir welded at the channel to plasticize the material adjacent to the channel of both the first structural member and the second structural member to form friction stir weld joint. This allows three dimensional objects to be formed from the friction stir weld joined members as opposed to merely allowing the joining of flat two dimensional surfaces.

Another embodiment in the present invention provides a method for joining structural members. This involves aligning the first structural member to a second structural member. The first structural member has a channel with which to receive a portion of the second structural member. As in the prior embodiment, this channel serves as a guide with which to position the first structural member relative to the second structural member. For example, the first and second structural member may be an I-beam or C-beam wherein the channel is placed within the horizontal members and not the vertical webs of the I-beam. Once fitted together FSW takes place at the channel to join the first structural member to the second structural member. This results in plasticizing and mixing the materials within and adjacent to the channel of both the first and the second structural member to form a single continuous joint at the channel.

Additional embodiments may place an adhesive or barrier material that may both assist in fitting the first structural member to the second structural member prior to the friction stir weld as well as providing a barrier as the adhesive or barrier material is extruded into interface cavities at the friction stir weld joint. This method is particularly useful for structures where weight is a concern, such as an aircraft using aluminum or aluminum alloy structural members. By eliminating the need reinforce structural components due to the coupling of structural members using traditional fastener methods, the weight associated with these structural; members may be greatly reduced.

Another embodiment of the present invention provides a similar method for joining structural members. Again the first structural member is aligned and fitted to a second structural member wherein a channel within the first structural member receives a portion of the second structural member. In addition to this channel which may be used to fit the first structural member to the second structural member a male connector within either the first structural member and/or second structural member may be received within a female receptacle of the second structural member and/or first structural member. This may further facilitate the setup and alignment process. The materials of the male connector and female receptacle may be friction stir welded at the interface to further enhance the joint coupling the first structural member to the second structural member. Additionally, adhesive or barrier material may be placed at the channel, male connector, and/or female receptacle to assist in fitting and preventing contaminants from entering or penetrating the interface cavities that remain after joining the structural members.

### BRIEF DESCRIPTION OF THE DRAWINGS

For a more complete understanding of the present invention and the advantages thereof, reference is now made to the following description taken in conjunction with the accompanying drawings in which like reference numerals indicate like features and wherein:

FIGS. 1A and 1B provide a cross section of a typical I-Beam and C-Beam;

FIG. 2 illustrates the Friction Stir Welding (FSW) joining method;

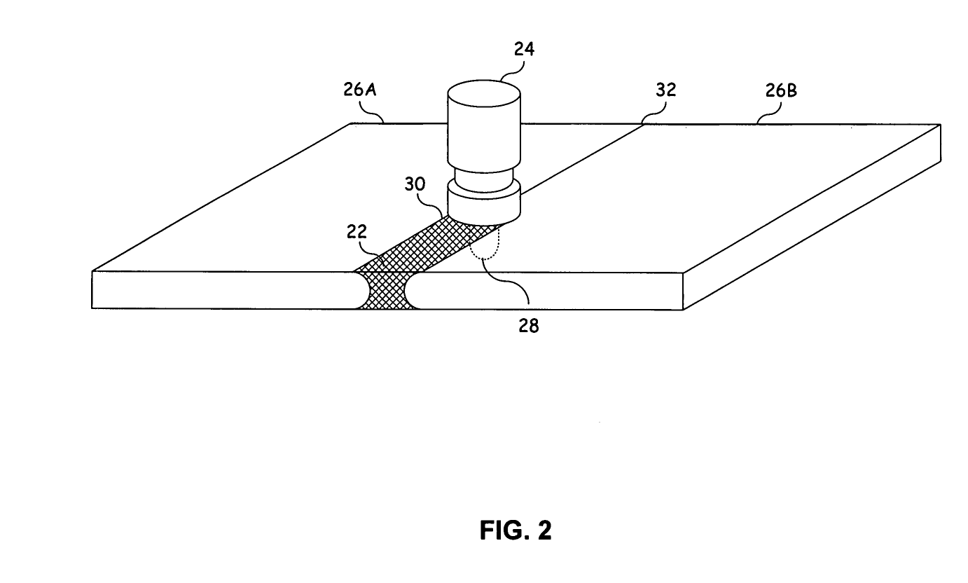

FIG. 3 shows a first structural member in the process of being fitted to a second structural member in accordance with an embodiment of the present invention;

FIG. 4 shows a first structural member having a groove or channel operable to receive and align a second structural member in accordance with an embodiment of the present invention;

FIG. 5 shows a first structural member having a groove or channel joined by a FSW to a second structural member in accordance with an embodiment of the present invention;

FIG. 6 shows a first structural member and a second structural member, initially fitted together by male connectors and female receptacles, and then permanently joined by a FSW to in accordance with an embodiment of the present invention; and

FIG. 7 provides a logic flow diagram describing the joining of a first structural member and a second structural member initially fitted together and then permanently joined by a FSW to in accordance with an embodiment of the present invention.

### DETAILED DESCRIPTION OF THE INVENTION

Embodiments of the present invention are illustrated in the FIGUREs, like numerals being used to refer to like and corresponding parts of the various drawings.

The present invention provides a means of joining a first structural member and a second structural member that substantially addresses the above identified needs. The first structural member is joined to a second structural member to form a three dimensional joint. This involves first aligning a first structural member to a second structural member. The first structural member has a channel with which to receive a portion of the second structural member. Once aligned, the first structural member and second structural member may be friction stir welded at the channel to plasticize the material adjacent to the channel of both the first structural member and the second structural member to form a friction stir weld joint. This allows three dimensional objects to be formed from the friction stir weld joined members as opposed to merely allowing the joining of flat two dimensional surfaces.

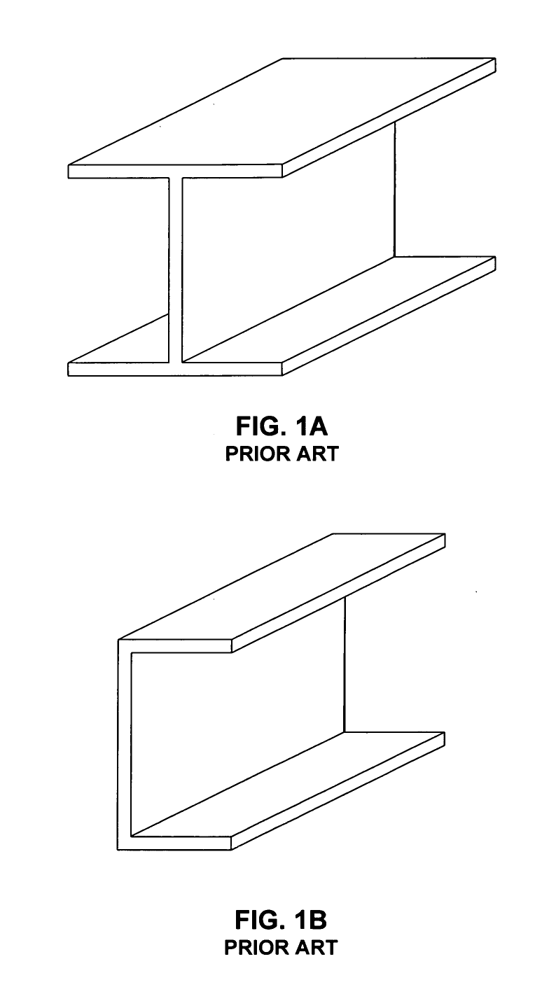

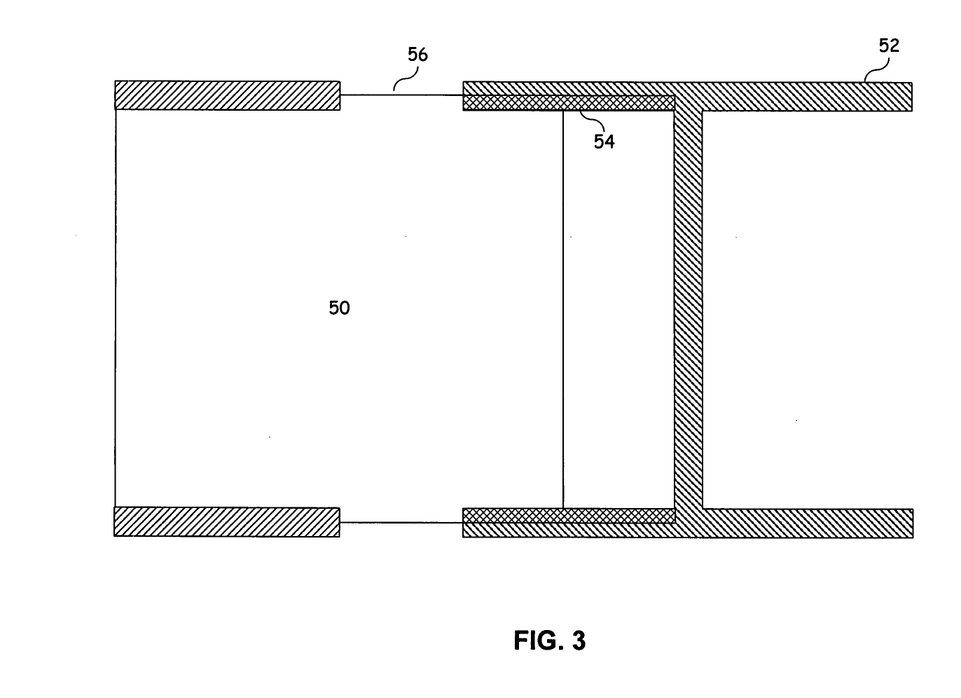

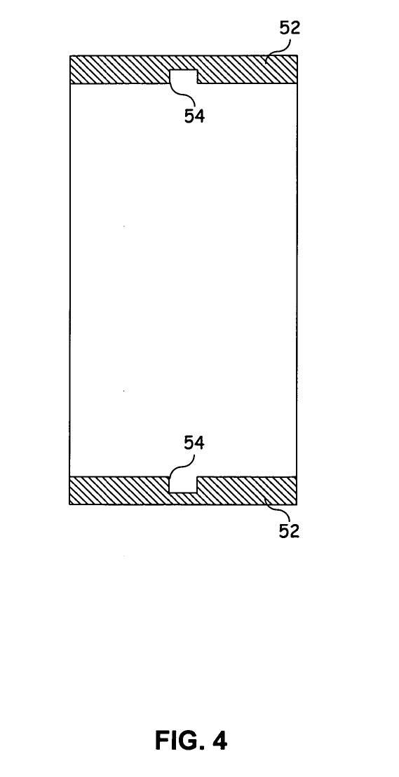

FIG. 3 shows a first structural member. FIG. 3 depicts two I-beams, 50 and 52. These may be similar to the beams discussed with reference to FIGS. 1A and 1B. However, unlike the beams of FIGS. 1A and 1B, I-beam 52 has a channel or groove 54 cut into the horizontal surface operable to receive a portion of the web 56 of I-beam 50 within the channel. In so doing, I-beam 50 is aligned to I-beam 52. FIG. 4 provides a side view of a portion of I-beam 52 wherein grooves 54 have been cut into the horizontal members 58 of I-beam 52. Channels 54 as previously discussed with respect to FIG. 3 may receive a portion of the member to be joined and aligned. Additionally channels 54 assist in fitting and holding member 52 and member 50 during the friction stir weld process. This greatly reduces the time required to setup and align structural members prior to permanently joining the members

To further improve the friction stir weld joint of member 50 and 52, an adhesive may be deposited within the channel in order to assist in the fitting. This adhesive may also form a barrier to prevent moisture or other contaminants from penetrating the friction stir weld joint or any spaces (interface cavities) or gaps left following the joining process.

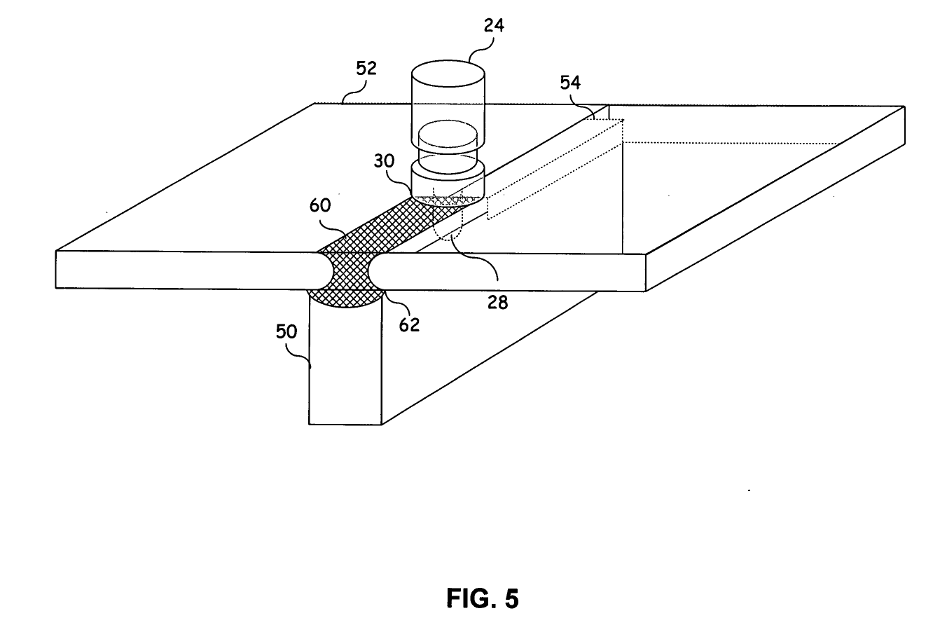

FIG. 5 provides an isometric view of two members, 50 and 52, in the process of forming a FSW joint. Here a portion of structural member 50 is received within channel 54 cut into the horizontal component 58 of I-beam 52. As previously stated, adhesive or other barrier protection material may be placed within the channel to assist in fitting, at least temporarily, member 50 to member 52 prior to the FSW process. Rotating tool 24 inserts probe 28 into the member 52 above channel 54. This probe may also extend into the portion of member 50 contained within channel 54, however this is not required. Rotation of probe 28 and the shoulder 30 of rotating tool 24 will plasticize materials region 60. These materials include both materials within and adjacent to channel 54 from both structural member 50 and 52. This causes the material adjacent to the channel to plasticize as rotating tool 24 follow the path of channel 54. This eliminates the interface and forms a continuous joint that couples structural member 52 to member 50.

Unlike prior applications of FSW where two pieces were abutted against each other and friction stir welded to form a single continuous panel. Embodiments of the present invention allow the creation of a three dimensional structure. Additionally, the application of FSW limits any deformation of the vertical portions of the members to be joined. Thus preserving the load bearing capability of the beams.

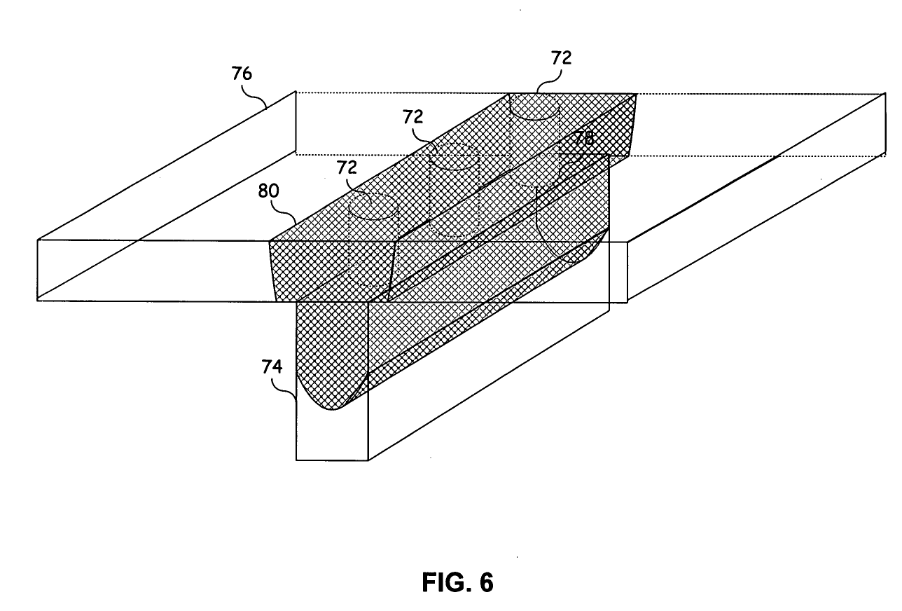

FIG. 6 provides an isometric view of two structural members, structural members 74 and 76. These members are fitted using male portions 72 of structural members 74 that are received within female receptacles 76 and 78 of structural members 76. These male connectors and female receptacles assist in fitting structural members 74 to structural member 76 prior to the FSW process wherein the FSW process plasticizes region 80 that includes both the male connectors and female receptacles, as well as adjacent material within both structural members to form a continuous joint able to better distribute mechanical loads between structural member 74 to structural member 76.

In the embodiment presented previously, one can deposit the adhesive or barrier material in the channel 54 of FIGS. 3, 4, and 5 or within receptacle 78 of FIG. 6. This material may then be forced from the receptacles or channels and into interfacing cavities as the material is plasticized. This may fill any free space with the adhesive or barrier material. Filling these spaces prevents penetration of contaminants such as moisture into the FSW joint. Such FSW joints are particularly applicable to structural members made of materials such as aluminum or aluminum alloys used in the fabrication of aircraft. Embodiments of the present invention enable the overall structural requirements and weight of the structural members to be reduced by eliminating localized regions of high structural load caused by drilling holes or other traditional fastener methods. Additionally, the mechanical loads from one structural member may be transferred throughout the continuous joint as opposed to localized fasteners where the two or more structural members meet.

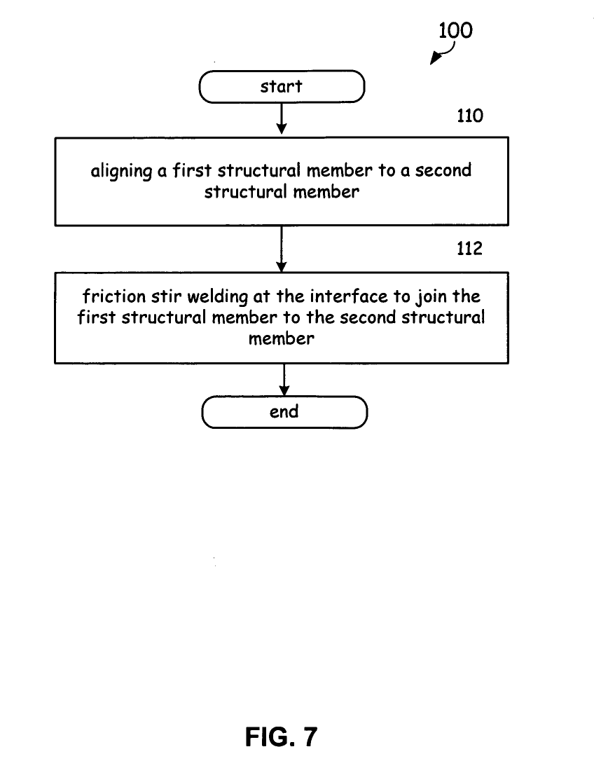

FIG. 7 provides with a logic flow diagram that may be used to illustrate various embodiments in the present invention wherein structural members are joined together using FSW joints. Operations 100 began by first aligning and fitting a first structural member to a second structural member in Step 110. This may be achieved by cutting into the first structural member a channel with which to receive a portion of the second structural member. Alternatively, or in combination, male connectors of either the first or second structural member may be aligned to and placed within female receptacles of the second and/or first structural member to fit these members together prior to the FSW. In either case, FSW is performed in Step 112 at the interface of the first and second structural members to join together the first and second structural members. Additional steps may require the placing of an adhesive or barrier material within the channel, upon the male connectors, or within the female receptacles. This adhesive or barrier material fills interface cavities to prevent contaminants from entering.

This invention solves prior problems by using the existing structural members, such as I-beams C-beams, that incorporate alignment guides (i.e. channels, connectors, and/or receptacles) to fit and FSW these materials to form three dimensional shapes such as T-joint configurations. By incorporating a groove or channel into the horizontal pieces and inserting the vertical pieces into these alignment guides, both members are joined together without disturbing the radius of the upstanding channel or groove. This joint can be further enhanced through the application of an adhesive or barrier material near the top of the alignment guide which will allow load transfer of material not joined by the FSW. The adhesive or barrier material acts to deny penetration into the joint by moisture or other contaminants. This adhesive facilitates fitting the parts (i.e. structural members), during setup.

The T grooved or channel T FSW joint provided by embodiments of the present invention has many advantages. First the drilling of holes and fastener installation is eliminated for assembly of structure members. In so doing, the fatigue lives of the structural members are extended through the elimination of localized stresses concentrated by these holes. Stiffness can be distributed over the entire cross section versus 2 or 3 bolts/fasteners interfaces enabling lower overall weight of the structural members and structure. Set up time is reduced by using the adhesive to locate the mating parts. This reduces or eliminates complex tooling requirements. Pull off strength and fatigue life in the finished structure may be improved by the addition of adhesives. The adhesive also fills the interface cavities disallowing water or contaminant entrapment. In so doing crevice corrosion is inhibited. Cold spray and adhesives improve the stiffness and rigidity of the finished assembly by improving the stiffener effectiveness. Nascent adhesive from the weld joint also provides a visual indicator that adhesive materiel is present in the weld joint, thus simplifying NDE verification.

In summary, embodiments of the present invention provide a three dimensional joint formed by coupling (joining) a first structural member and a second structural member. This involves first aligning a first structural member to a second structural member. The first structural member has a channel with which to receive a portion of the second structural member. Once aligned, the first structural member and second structural member may be friction stir welded at the channel to plasticize the material adjacent to the channel of both the first structural member and the second structural member to form a FSW joint. This allows three dimensional objects to be formed from the FSW joined members as opposed to merely allowing the joining of flat two dimensional surfaces.

Although the present invention is described in detail, it should be understood that various changes, substitutions and alterations can be made hereto without departing from the spirit and scope of the invention as described by the appended claims.

What is claimed is:

1. A method for joining structure members, comprising:
aligning a first structural member to a second structural member, the first structural member having a channel to receive a portion of the second structural member; and
friction stir welding (FSW) at the channel to join the first structural member to the second structural member.

2. The method of claim 1, further comprising placing an adhesive material at the channel, the adhesive material operable to fit the first structural member to the second structural member prior to FSW.

3. The method of claim 2, further comprising preventing moisture penetration into a FSW joint formed by the first structural member and the second structural with the adhesive material.

4. The method of claim 1, wherein the first structural member and the second structural member are within a vehicle frame.

5. The method of claim 1, wherein the first structural member and the second structural member comprise:
a box beam;
an I-beams;
a double I-beam; or
a C-Beam.

6. The method of claim 1, wherein the first structural member and the second structural member comprise an aluminum alloy.

7. The method of claim 1, further comprising:
inserting a male connector of the first structural member and/or second structural member into a female receptacle of the second structural member and/or first structural member; and
friction stir welding materials of the male connector into the female receptacle to create a FSW coupling.

8. A method for joining structural members, comprising:
aligning a first structural member to a second structural member, the first structural member having a channel to receive a portion of the second structural member;
inserting a male connector of the first structural member and/or second structural member into a female receptacle of the second structural member and/or first structural member; and
friction stir welding (FSW) at the channel and a male connector/female receptacle interface to join the first structural member to the second structural member.

9. The method of claim 8, further comprising placing an adhesive material at the channel, the male connector, and/or the female receptacle, the adhesive material operable to fit the first structural member to the second structural member prior to FSW.

10. The method of claim 9, further comprising preventing penetration of contaminates into a friction stir weld joint formed by the first structural member and the second structural, the penetration prevented with the adhesive material.

11. The method of claim 8, wherein the first structural member and the second structural member are within a vehicle frame.

12. The method of claim 8, wherein the first structural member and the second structural member comprise:
a box beam;
an I-beams;
a double I-beam; or
a C-Beam.

13. The method of claim 1, wherein the first structural member and the second structural member comprise an aluminum alloy.

14. A friction stir weld joint, comprising:
a first structural member, the first structural member having a channel;
at least one second structural member, the channel of the first structural member receives a portion of the at least one second structural member, the materials of the first structural member and at least one second structural member friction stir welded at the interface of the first structural member and at least one second structural member at the channel.

15. The friction stir weld joint of claim 14, wherein the channel is within a horizontal member of the first structural member, the channel receives a vertical member of the second structural member.

16. The friction stir weld joint of claim 14, wherein a barrier material within the channel fills interface cavities at the friction stir weld joint to prevent contamination from entering the friction stir weld joint.

17. The friction stir weld joint of claim 14, further comprising:
a male connector of the first structural member and/or second structural member;
a female receptacle of the second structural member and/or first structural member operable to receive the male connector, the materials of the male connector friction stir welded into the female receptacle.

18. The friction stir weld joint of claim 14, wherein an adhesive material at the channel, the male connector, and or the female receptacle, the adhesive material operable to fit the first structural member to the second structural member prior to friction stir welding.

19. The friction stir weld joint of claim 14, wherein the first structural member and the second structural member are within a vehicle frame.

20. The friction stir weld joint of claim 14, wherein the first structural member and the second structural member comprise:
a box beam;
an I-beams;
a double I-beam; or
a C-Beam.

21. The friction stir weld joint of claim 14, wherein the first structural member and the second structural member comprise an aluminum alloy.
